(19) United States
(12) Patent Application Publication
(10) Pub. No.: US 2014/0212834 A1
(43) Pub. Date: Jul. 31, 2014

(54) ENDODONTIC CLEANING INSTRUMENT AND APPARATUS

(71) Applicant: Ghassan YARED, Toronto (CA)

(72) Inventor: Ghassan YARED, Toronto (CA)

(21) Appl. No.: 14/168,033

(22) Filed: Jan. 30, 2014

(30) Foreign Application Priority Data
Jan. 31, 2013 (CA) 2806217

(51) Int. Cl. A61C 5/02

(52) U.S. Cl. CPC A61C 5/023
USPC 433/81; 433/102

(57) ABSTRACT

A cleaning instrument for an endodontic procedure such as a root canal provides a distal portion for agitating an irrigant, comprising in some embodiments agitating structures that stir the irrigant to assist in removing the smear layer and dislodging loosely adhered organic debris. The structures may also be designed to assist in evacuating irrigant from the canal. Some embodiments provide orifices through which an irrigating fluid can traverse the distal portion of the instrument and enter the canal to wash away loosened debris and sterilize the canal.

### FIELD OF THE INVENTION

This invention relates to endodontic instruments.

### BACKGROUND OF THE INVENTION

An important endodontic procedure, known as a “root canal” procedure, involves removing organic material from the root canals of an infected tooth and filling the canal with an inert obturating material such as gutta percha gum.

An effective root canal procedure avoids extraction of the infected tooth. In this procedure, a dentist or endodontist utilizes a series of endodontic instruments, for example files, for the debridement, cleaning and sterilization of the root canal. These files are rotated within the canal to clean the canal surfaces, removing debridement (organic) material in the process, facilitating improved irrigation, and in some cases shaping the canal for easier filling with the obturating material.

Root canal preparation, and root canal retreatment (to repair a defective root canal procedure), are typically effected by motor-driven instruments such as files. Retreatment can be defined as a procedure to remove root canal filling materials from the tooth, followed by cleaning, shaping and obturating the canals.

Once the pulp has been removed from the root canal, a smear layer remains. The smear layer is potentially infected, and its removal allows more efficient penetration of intracanal medications into the dentinal tubules and a better interface between the filling material and the root canal walls. A final flush with chelating agents and antiseptic irrigating solutions is needed to remove the smear layer. However, their effectiveness remains limited in the apical area of the prepared canal. This is particularly true for curved root canals and even on single-rooted teeth. Therefore, the improvement of irrigating protocols is essential during root canal treatment in order to achieve better cleaning efficiency especially in the very complex apical area. Currently, several techniques and systems are available and reported to improve final irrigation by irrigant activation and agitation before obturation.

It is thus advantageous to perform the debridement of the canal using an active instrument. For example, U.S. Pat. No. 8,328,552 issued Dec. 11, 2012 to Ruddle et al., which is incorporated herein by reference, describes a flexible, non-metallic activator which vibrates at sonic (1-10 KHz) or ultrasonic (25-30 KHz) frequencies to actively dislodge the smear layer and organic debris from the canal wall, while at the same time irrigating the canal to wash away the debris and sterilize the canal. The disadvantage to such a system is that the efficacy of the sonic-driven activators is not significantly greater than manual agitation of irrigant fluid in the canal by an activator (Caron et al. Effectiveness of different final irrigant activation protocols on smear layer removal in curved canals. Journal of Endodontics 2010 August;36(8):1361-6). Also, an activator made of a flexible non-metallic material similar to Ruddle's in many cases cannot be driven using ultrasonic energy because of the possibility of fracture of the activator.

Ultrasonic-driven activators are available, but they are made of a metallic rigid material; these activators are aggressive and can cause problems, especially in curved canals.

### BRIEF DESCRIPTION OF THE DRAWINGS

In drawings which illustrate by way of example only a preferred embodiment of the invention,

FIG. 1 is a schematic view of an apparatus according to the invention.

FIG. 2 is an elevation of the proximal portion of the instrument of FIG. 1

FIG. 3 is an enlarged elevation of one embodiment of the distal portion of the instrument of FIG. 1.

FIG. 4 is an enlarged elevation of a further embodiment of the distal portion of the instrument of FIG. 1.

FIG. 5 is a partial elevation of an embodiment of the instrument of the invention having a helical groove.

FIG. 6 is an elevation of an embodiment of the invention wherein irrigant fluid is fed through a wall of the instrument.

### DETAILED DESCRIPTION OF THE INVENTION

The present invention provides a motor-driven instrument for cleaning the canal during a root canal procedure, the distal portion of which provides an activator that is effective, safe to use on a tooth and will not fracture in use. Advantageously, the instrument may be driven by the same motor used to drive the endodontic files used in the root canal procedure, which reduces costs by avoiding an additional costly and bulky ultrasonic or sonic device. Thus the invention requires less equipment, less maintenance and less space in comparison with ultrasonic- and sonic-driven activators.

Another advantage is that the instrument may be used in general with the devices used to drive endodontic files for the canal preparation, and more specifically with the same reciprocating movement that is used for the endodontic files in the canal preparation process. Therefore, the procedure becomes simpler with a shorter learning curve and faster (no need to change devices in order to switch between instruments) and easier to learn.

There are further advantages in the embodiments of the instrument in which the activator provides agitating structures for enhancing the agitation of the irrigant and the evacuation of irrigant from the canal, which in its turn allows for a more irrigant to be introduced into the canal. In embodiments that provide openings for irrigant injection through the instrument, this can be effected without removing the activator tip from the canal.

The invention thus provides a cleaning instrument 30 for an endodontic procedure such as a root canal and an apparatus utilizing such an instrument. In the preferred embodiment the instrument 30 comprises a distal portion 40 providing agitating structures 42 which agitate the irrigant to provide a stirring action. These agitating structures 42 may for example comprise small bristles or fins along the surface of the activator. The diameter of the distal portion 40 including such structures is smaller than the diameter of the prepared canal, to allow for agitation of the irrigant fluid and to allow the tip of the activator at the distal portion 40 of the instrument 30 to reach the end of the prepared canal.

As the distal portion 40 of the instrument 30 is used within the root canal, its lateral walls and/or agitating structures will tend to contact and rub against the surfaces of the root canal, to physically enhance the chemical action of the irrigant fluid, but because the instrument 30 is made from a flexible, non-metallic and non-cutting material, this occurs without the risk of damaging the internal walls of the root canal. This rubbing action will help to remove debridement material that is loosely adhered to the canal wall.

In some embodiments openings 42 are provided through which an irrigating fluid can traverse the tip or the wall of the distal portion 40 of the instrument 30 and enter the canal to wash away loosened debris and sterilize the canal. In some embodiments the agitating structures 44 are aligned so as to assist in evacuating irrigant and entrained debris from the canal.

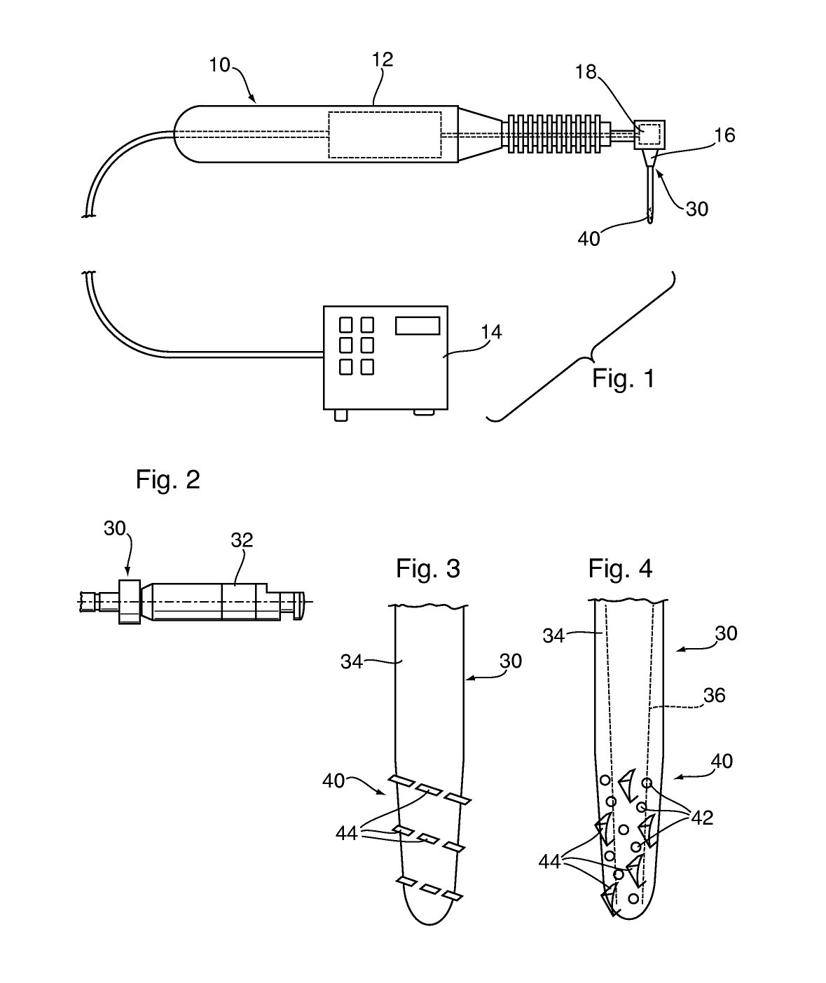

FIG. 1 illustrates an apparatus 10 suitable for driving the instrument 30. In the preferred embodiment the apparatus is capable of driving the instrument 30 in a continuous rotary motion, a reciprocating rotary motion and/or a reciprocating axial motion. Examples of apparatuses which can drive the instrument 30 in a rotating motion are described and illustrated in the applicant's co-pending published U.S. patent application no. 20120225406, which is incorporated herein by reference, and U.S. Pat. No. 6,293,795 issued Sep. 25, 2001 to Johnson, which is incorporated herein by reference. An example of an apparatus which can drive the instrument 30 in a reciprocating axial motion is the applicant's co-pending Canadian patent application no. 2,799,718 filed Dec. 13, 2012, which is incorporated herein by reference.

These apparatuses may be adapted to inject irrigant through the wand of the apparatus in any suitable fashion, for example as described and illustrated in U.S. Patent Application No. US2012/0040306 (Johnson) published Feb. 16, 2012, which is incorporated herein by reference. FIG. 2 illustrates the proximal portion 32 an instrument 30 according to the invention. In its basic form the proximal portion for rotationally and axially fixed attachment of the instrument 30 to the motor-driven end of the wand 12, and an intermediate portion 34 terminating in a distal portion 40 comprising an activator for agitating an irrigant. The instrument is formed in any suitable fashion from a soft material that will not damage the tooth, degrade or fracture during use.

In the embodiment illustrated the proximal end 32, shown in FIG. 2, is configured to releasably engage the wand 12 of the apparatus 10, as shown in FIG. 1, for example locking into a complementary chuck 16 in a head 18 of the wand 12. An intermediate portion 34 of the instrument 30 terminates in a distal portion 40. In the embodiments in which the instrument 30 is adapted to inject irrigant into the canal, at least one lumen 36 (shown in phantom lines in FIG. 4) extends through the instrument 30, terminating at the distal portion 40. In this embodiment the distal portion 40 is thus in fluid-tight communication with the proximal end 32 via the lumen 36, which extends axially through the entire instrument 30.

In irrigating embodiments the activator at the distal portion 40 comprises at least one orifice 42, preferably a plurality of orifices 42 through which an irrigating fluid pumped from the base unit 14 or an auxiliary pump (not shown) egresses from the distal portion 40 and enters the canal. The tip of the distal portion 40 can be closed with orifices 42 disposed about the side wall of the distal portion 40, as shown in FIG. 4, and/or the tip of the distal portion 40 can provide an orifice (not shown). The irrigating fluid is preferably introduced into the canal at a velocity sufficient to dislodge loose organic matter and other contaminants, and entrain contaminants in a flow of fluid out of the canal. The pressure supplied by the pump, the flow rate of the irrigant, the internal diameter of the lumen 36 and the diameters of the orifices 42 all affect the velocity at which the irrigant is dispensed in the canal.

The activator tip preferably provides agitating structures 44 which physically stir the irrigant to assist in dislodging debris that loosely adheres to the canal wall, and to assist in the evacuation of irrigant from the canal. These structures, for example fins of varying configurations, as shown in FIGS. 3 and 4, may be arranged in any desired pattern, having regard to the nature of the motion (continuous rotary, reciprocating rotary or reciprocating axial) to which the instrument 30 is subjected. The activator at the distal portion 40 is preferably (but not necessarily) tapered, for example conical or frusto-conical as shown, for ease of insertion and use during the root canal procedure.

The distal portion 40 comprising agitating structures is preferably formed integrally with the instrument 30, for example in the preferred embodiment shown where the instrument is formed from a material which is non-abrasive and sufficiently soft as to be unable to bind on the canal or otherwise harm the tooth. Instruments 30 having different configurations of distal portions 40 can be easily interchanged as necessary during the root canal procedure by removal from the chuck 16 and replacement with a different instrument. Alternatively, but less preferably, the agitating structures 44 may be formed on a separate tip (not shown) which can be attached to the distal portion 40 of the instrument in any secure rotationally and axially fixed fashion.

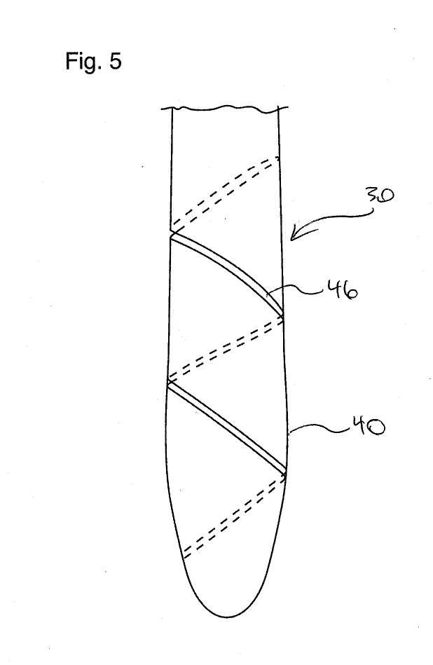

For example, without limitation, the activator at the distal portion 40 of the instrument 30 may be smooth-walled (for example conical or frusto-conical) without any abrading structures but formed from a natural abrading material (e.g. non-degrading rubber). Alternatively, the distal portion may be provided with agitating structures 44 such as fins, bristles, embossments and/or other like structures, which result in both more effective release of loosely adhered debris and better agitation of the irrigant fluid; and/or the distal end of the device can have a helically-oriented groove 46 which is advantageously used in both reciprocating and continuous rotary motion of the instrument 30, as shown in FIG. 5. The helical groove provides a means for actively removing irrigant from the canal, which is advantageous where a continuous or reciprocating rotary motion is applied to the instrument 30.

The use of bristles increases the selection of materials from which the distal portion 40 can be formed. Bristles on the distal portion 40 may for example be similar to the device described and illustrated in U.S. Pat. No. 6,981,869, which is incorporated herein by reference, or in published U.S. Patent Application No. 2012/0222229, which is incorporated herein by reference. The bristles are preferably embedded into the distal portion 40 when the instrument 30 is molded or otherwise formed.

The distal portion 40 may alternatively, or additionally, be provided with agitating structures such as axially-, radially- or helically-oriented fins 44 to enhance irrigant agitation in the canal. The shapes and the positions of the fins 44 may depend on the motion of the tip 40; for example, generally radially oriented fins (as shown in FIG. 3) would be advantageously used in an axial reciprocation of the instrument 30; generally axially oriented fins (shown in FIG. 4) may be advantageously used in a rotary reciprocation of the instrument 30; and helically aligned fins (shown in FIG. 3) would be advantageously used in both reciprocating and continuous rotary motion of the instrument 30. The fins are preferably formed integrally with the distal portion 40 when the instrument 30 is molded or otherwise formed.

In each of these examples the distal portion 40 may provide orifices 42 for irrigant delivery. Where no orifices 42 are provided, irrigant fluid is fed into the canal by a separate irrigator (not shown), and the agitating structures 44 assist in the evacuation of the fluid from the canal during the root canal procedure, in order to carry away loose debris and contaminants. Where orifices 42 are provided they are interspersed with agitating structures 44, as shown in FIG. 4, so that the agitating structures 44 do not occlude the orifices 42 and the orifices 42 do not alter the configuration of the agitating structures 44.

A combination of axial and rotary motions would most beneficially employ an instrument 30 having a distal portion 40 providing a combination of such fins 44. The fins 44 can be aligned horizontally on the activator following a helical pattern to enhance the evacuation of the irrigant in a coronal direction (depending on the rotational motion of the distal portion 40). The helical fins 44 can be machined into the distal portion 40, molded integrally with the distal portion 40 or otherwise formed in any suitable fashion.

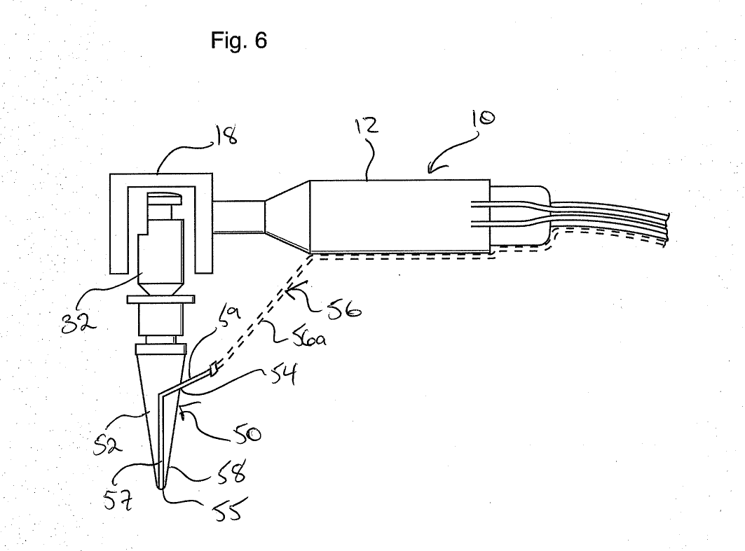

FIG. 6 illustrates an embodiment of the invention in which irrigant is fed through a side wall of the instrument 50. In this embodiment the instrument 50, similarly formed from a soft, flexible material as in the earlier embodiments, has an orifice 54 through side wall 52 into which an irrigating tube 56 extends to feed irrigant to the distal portion 58 of the instrument 50. The irrigating tube may for example be external to the wand 12, optionally affixed along the housing of the wand 12 for convenience and easier manipulation. The irrigating tube 56 is in fluid-tight communication with a lumen 57, which in this embodiment does not extend to the mesial portion of the instrument 50 but instead starts at an intermediate position through the instrument wall 52 as shown. A small lateral tube 59 may be provided to introduce the irrigant fluid into the instrument, to which the irrigant tube 56 is connected in fluid-tight communication as shown, or the irrigant tube 56 may be formed integrally with the lumen 57.

In the embodiment of FIG. 6 the irrigant tube 56 should be flexible and have enough freedom of motion, for example at 56a, to permit rotary reciprocation. The irrigant tube 56 is attached externally to the wand 12 and optionally along the flexible tubing that fees electricity to the motor (or air, in the case of a pneumatic motor), and extends to a pressurized reservoir (not shown) containing the irrigant. The irrigant flows under the desired pressure into the instrument 50 and then into the canal through an opening 55 at the tip of the distal portion 58, or optionally through lateral holes (not shown) as described above. This system provides the advantages of being external to the wand 12, so that the use of corrosive irrigants will not damage the internal parts of the wand 12 over time; and provides an easier way to dispense the irrigant into the canal (compared to the irrigant being required to flow through the proximal end 32) while the instrument 50 is being used in axial reciprocation and rotational reciprocation. It also simplifies the manufacture of the wand 12. However, this system cannot be used with continuous rotation, which is possible using an internal system where the irrigant is conveyed into the instrument through proximal end 32, because the flexible tubing would wind around the instrument 50 during continuous rotation. The instrument 50 may optionally be provided with one or more of the structures described above (not shown) to enhance the chemical action of the irrigant fluid and/or evacuation of irrigant from the canal.

Various embodiments of the present invention having been thus described in detail by way of example, it will be apparent to those skilled in the art that variations and modifications may be made without departing from the invention. The invention includes all such variations and modifications as fall within the scope of the appended claims.

I claim:

1. An endodontic instrument for use with an apparatus comprising a motor for driving an end of a wand in a rotary motion or an axial reciprocating motion or a rotary reciprocating motion, or any combination thereof, comprising
a proximal portion for rotationally and axially fixed attachment of the instrument to the end of the wand, and
a distal portion for agitating an irrigant,
the instrument being formed from a flexible material.

2. The instrument of claim 1 wherein the distal portion comprises structures for agitating the irrigant.

3. The instrument of claim 2 wherein the structures comprise bristles or fins, or both.

4. The instrument of claim 3 wherein the bristles or fins, or both, are disposed in a generally helical pattern about the distal portion.

5. The instrument of claim 1 comprising a generally helical groove about the distal portion.

6. The instrument of claim 1 wherein the instrument comprises a lumen for conveying the irrigant and the distal portion comprises at least one orifice through which the irrigant egresses from the instrument, the distal portion being in fluid-tight communication with a conduit for feeding the irrigant.

7. The instrument of claim 6 wherein the distal portion comprises a plurality of orifices.

8. The instrument of claim 6 wherein the distal portion comprises structures for agitating the irrigant.

9. The instrument of claim 8 wherein the structures comprise bristles or fins, or both.

10. The instrument of claim 9 wherein the bristles or fins, or both, are disposed in a generally helical pattern about the distal portion.

11. The instrument of claim 6 wherein the irrigant is conveyed into the lumen through a side wall of the instrument via an external tube.

12. An endodontic apparatus comprising a motor for driving an end of a wand in a rotary motion or an axial reciprocating motion or a rotary reciprocating motion, or any combination thereof, comprising an endodontic instrument comprising
a proximal portion for rotationally and axially fixed attachment of the instrument to the end of the wand, and
a distal portion for agitating an irrigant,
the instrument being formed from a flexible material.

13. The apparatus of claim 12 wherein the distal portion comprises structures for agitating the irrigant.

14. The apparatus of claim 12 wherein the structures comprise bristles or fins, or both.

15. The apparatus of claim 14 wherein the bristles or fins, or both, are disposed in a generally helical pattern about the distal portion.

16. The apparatus of claim 12 comprising a generally helical groove about the distal portion.

17. The apparatus of claim 12 wherein the instrument comprises a lumen for conveying the irrigant and the distal portion comprises at least one orifice through which the irrigant egresses from the instrument, the distal portion being in fluid-tight communication with a conduit for feeding the irrigant.

18. The apparatus of claim 17 wherein the distal portion comprises a plurality of orifices.

19. The apparatus of claim 17 wherein the distal portion comprises structures for agitating the irrigant.

20. The apparatus of claim 19 wherein the structures comprise bristles or fins, or both.

21. The apparatus of claim 20 wherein the bristles or fins, or both, are disposed in a generally helical pattern about the distal portion.

22. The apparatus of claim 17 wherein the irrigant is conveyed into the lumen through a side wall of the instrument via an external tube.
